(19) United States
(12) Patent Application Publication
(10) Pub. No.: US 2015/0322292 A1
(43) Pub. Date: Nov. 12, 2015

(54) TWO-COMPONENT WATER-BASED COMPOSITIONS THAT PRODUCE HIGH GLOSS POLYURETHANE COATINGS WITH GOOD APPEARANCE

(71) Applicant: Bayer MaterialScience LLC, Pittsburgh, PA (US)

(72) Inventors: Joseph Pierce, Pittsburgh, PA (US); Kathy Allen, Scenery Hill, PA (US); Irene Yano, McKees Rocks, PA (US)

(73) Assignee: Bayer MaterialScience LLC, Pittsburgh, PA (US)

(21) Appl. No.: 14/270,554

(22) Filed: May 6, 2014

(51) Int. Cl. C09D 175/14

(52) U.S. Cl. CPC C09D 175/14

(57) ABSTRACT

Two-component water-based coating compositions are described. The coating compositions include a mixture of components that includes: (a) an aqueous dispersion of a resin comprising functional groups reactive with isocyanates; and (b) a hydrophilicized polyisocyanate. The mixture includes (i) propylene carbonate that is present in the mixture in an amount of greater than 2 percent by weight, based on the total weight of the mixture; and (ii) a ratio of isocyanate groups to functional groups reactive with isocyanates of 0.8 to 3.0:1.

### FIELD

The present invention relates to two-component water-based coating compositions, methods for producing high gloss polyurethane coatings, and substrates at least, partially coated with such a high gloss polyurethane coating.

### BACKGROUND

Two-component polyurethane forming coating compositions are widely used because of the many advantageous properties they exhibit. These coating compositions generally comprise a liquid binder component and a liquid hardener/crosslinker component. The liquid binder component may comprise an isocyanate-reactive component, such as a polyol, and the liquid crosslinker component may comprise a polyisocyanate. The addition reaction of the polyisocyanate with the isocyanate-reactive component, which can occur at ambient conditions, produces crosslinked polyurethane networks that form coating films.

Often for environmental or other reasons, water-based versions of such two-component coating compositions are desired, in which the liquid binder is dispersed in an aqueous medium and the isocyanate-reactive component comprises a hydrophilicized polyisocyanate. The appearance of coatings produced from such coating compositions is often very important, such as when the coating is employed as a top coat in, for example, automotive coating applications.

In these applications, it is often desirable that the coating exhibit a very high gloss, i.e., a 20° gloss of at least 80 gloss units. A problem that has been encountered with such ambient-curing, water-based two-component coating compositions that include a hydrophilicized polyisocyanate, and which produce such high gloss coatings, is a problem sometimes referred to as “pin-holing”. “Pin-holes” are tiny holes in the coating. To alleviate the problem of pin-holing, surface additives that change the surface tension of the coating are sometimes added to the formulation. A problem with such surface additives is that they can cause other appearance problems, such as, for example, cratering, orange-peel, and/or haze in the cured coating,

As a result, it would be desirable to provide two-component water-based polyurethane coating compositions utilizing a hydrophilicized polyisocyanate that produce a high gloss coating that is substantially free of pin-holes and has a high distinctness of image (“DOI”). DOI, as will be appreciated, is an indicator of the lack of haze or orange peel, i.e., higher DOI means lower orange peel and haze. It would also be desirable to provide such a solution that is robust in that it can be used effectively with a variety of different isocyanate-reactive resins.

The present invention was made in view of the foregoing.

### SUMMARY OF THE INVENTION

In some respects, the present invention is directed to two-component water-based coating compositions comprising a mix cure of components comprising: (a) an aqueous dispersion of a resin comprising functional groups reactive with isocyanates; and (b) a hydrophilicized polyisocyanate, wherein the mixture: (i) comprises propylene carbonate that is present in the mixture in an amount of greater than 2 percent by weight, based on the total weight of the mixture; and (ii) has a ratio of isocyanate groups to functional groups reactive with isocyanates of 0.8 to 3.0:1.

The present invention also relates to, among other things, methods of using such coating compositions to provide high-gloss polyurethane coatings and coated substrates comprising a high-gloss polyurethane coating deposited from such compositions.

### DETAILED DESCRIPTION

Various embodiments are described and illustrated herein to provide an overall understanding of the structure, function, operation, manufacture, and use of the disclosed products and processes. It is understood that the various embodiments described and illustrated herein are non-limiting and non-exhaustive. Thus, the invention is not limited by the description of the various non-limiting and non-exhaustive embodiments disclosed herein. Rather, the invention is defined solely by the claims. The features and characteristics illustrated and/or described in connection with various embodiments may be combined with the features and characteristics of other embodiments. Such modifications and variations are intended to be included within the scope of the present invention. As such, the claims may be amended to recite any features or characteristics expressly or inherently described in, or otherwise expressly or inherently supported by, this specification. Further, Applicant reserves the right to amend the claims to affirmatively disclaim features or characteristics that may he present in the prior art. Therefore, any such amendments comply with the requirements of 35 U.S.C. §112 and 35 U.S.C. §132(a). The various embodiments disclosed and described in this specification can comprise, consist of, or consist essentially of the features and characteristics as described herein.

Any patent, publication, or other disclosure material identified herein is incorporated herein by reference in its entirety unless otherwise indicated, but only to the extent that the incorporated material does not conflict with existing definitions, statements, or other disclosure material expressly set forth in this specification. As such, and to the extent necessary, the express disclosure as set forth in this specification supersedes any conflicting material incorporated by reference herein. Any material, or portion thereof, that is said to be incorporated by reference into this specification, but which conflicts with existing definitions, statements, or other disclosure material set forth, herein, is only incorporated to the extent that no conflict arises between that incorporated material and the existing disclosure material. Applicant reserves the right to amend this specification to expressly recite any subject matter, or portion thereof, incorporated by reference herein.

Reference throughout this specification to “certain embodiments”, “some embodiments”, “various non-limiting embodiments,” or the like, means that a particular feature or characteristic may be included in an embodiment. Thus, use of such phrases, and similar phrases, in this specification does not necessarily refer to a common embodiment, and may refer to different embodiments. Further, the particular features or characteristics may be combined in any suitable manner in one or more embodiments. Thus, the particular features or characteristics illustrated or described in connection with various embodiments may be combined, in whole or in part, with the features or characteristics of one or more other embodiments. Such modifications and variations are intended to be included within the scope of the present invention. In this manner, the various embodiments described herein are non-limiting and non-exhaustive.

Other than where otherwise indicated, all numerical parameters contained herein are to be understood as being prefaced and modified in all instances by the term “about”, in which the numerical parameters possess the inherent variability characteristic of the underlying measurement techniques used to determine the numerical value of the parameter. At the very least, and not as an attempt to limit the application of the. doctrine of equivalents to the scope of the claims, each numerical parameter described herein should at least be construed in light of the number of reported significant digits and by applying ordinary rounding techniques.

Also, any numerical range recited herein is intended to include all sub-ranges subsumed within the recited range. For example, a range of “1 to 10” is intended to include all sub-ranges between (and including) the recited minimum value of 1 and the recited maximum value of 10, that is, having a minimum value equal to or greater than 1 and a maximum value equal to or less than 10. Any maximum numerical limitation recited herein is intended to include all lower numerical limitations subsumed therein and any minimum numerical limitation recited herein is intended to include all higher numerical limitations subsumed therein. Accordingly, Applicant reserves the right to amend this specification, including the claims, to expressly recite any sub-range subsumed within the ranges expressly recited. All such ranges are inherently described in this specification such that amending to expressly recite any such sub-ranges would comply with the requirements of 35 U.S.C. §112 and 35 U.S.C. §132(a).

The grammatical articles “a”, “an”, and “the”, as used herein, includes “at least one” and “one or more”, unless otherwise indicated, even if “at least one” or “one or more” is expressly used in certain instances. Thus, the articles are used herein, to refer to one or more than one (i.e., to “at least one”) of the grammatical objects of the article. By way of example, and without limitation, “a component” means one. or more components, and thus, possibly, more than one component is contemplated and may be employed or used m an implementation of the described embodiments. Further, the use of a singular noun includes the plural, and the use of a plural noon includes die singular, unless die context of the usage requires otherwise.

As used herein, “polymer” encompasses pre-polymers, oligomers and both homopolymers and copolymers; the prefix “poly” in this context referring to two or more. As used herein, the term “molecular weight”, when used in reference to a polymer, refers to the number average molecular weight (“Mₙ”), unless otherwise specified.

As used herein, the term “aliphatic” refers to organic compounds characterized by substituted or unsubstituted straight, branched, and/or cyclic chain arrangements of constituent carbon atoms. Aliphatic compounds do not contain aromatic rings as part of the molecular structure thereof. As used herein, the term “cycloaliphatic” refers to organic compounds characterized by arrangement of carbon atoms in closed ring structures. Cycloaliphatic compounds do not contain aromatic rings as part of the molecular structure thereof. Therefore, the term “aliphatic” encompasses aliphatic compounds and cycloaliphatic compounds.

As used herein, the term “diisocyanate” refers to a compound containing two isocyanate groups. As used herein, the term “polyisocyanate” refers to a compound containing two or more isocyanate groups. Hence, diisocyanates are a subset of polyisocyanates.

As indicated, embodiments of the present invention are directed to two-component water-based coating compositions. As used herein, the term “two-component coating composition” refers to a composition comprising at least, two components that are stored in separate containers because of their mutual reactivity. One component of such compositions comprises an isocyanate-functional component and another component of the composition comprises an isocyanate-reactive component. The two components are generally not mixed until shortly before application of the composition to a substrate. When the two separate components are mixed and applied as a film on a substrate, the mutually reactive compounds in the two components react to crosslink and form a cured coating film. As used herein, the term “coating composition” refers to a mixture of chemical components that will cure and form a coating when applied to a substrate. As used herein, the term “water-based” refers to compositions in which the carrier fluid or diluent is primarily water. For example, in some embodiments, at least 50% by weight, at least 60% by weight, at least 70% by weight, at least 80% by weight, at least 85% by weight, at least 90% by weight, at least 95% by weight, or, in some cases, at least 98% by weight of the carrier fluid, i.e., diluent, is water.

The coating compositions of the present invention comprise an aqueous dispersion of a resin comprising functional groups reactive with isocyanates. As used herein, “aqueous dispersion of a resin” means a stable dispersion of the resin in an aqueous medium principally comprising water, although small amounts of organic liquids may be present. In some embodiments, an organic solvent is present in such an aqueous dispersion in an amount of no more than 10% by weight, such as no more than 2% by weight, no more than 1% by weight, or no more than 0.1% by weight, based on the total weight of the dispersion.

As used herein, “functional groups reactive with isocyanates” or “isocyanate reactive” is synonymous with, and may be used interchangeably with, “active-hydrogen” groups, which refers to those groups that are reactive with isocyanates as determined by the Zerewitnoff test described in the JOURNAL OF THE AMERICAN CHEMICAL SOCIETY, Vol. 49, page 3181 (1927). Such groups include hydroxyl groups, primary or secondary amine groups, and thiol groups.

In certain embodiments of the present invention, the resin comprising functional groups reactive with isocyanates comprises an acrylic resin, such as an acrylic polyol. Moreover, in some of these embodiments, the acrylic resin comprises a copolymer that is a reaction product of reactants comprising: (a) up to 50% by weight, such as at least 10% by weight or at least. 20% by weight and up to 50% by weight or up to 30% by weight, of a cycloaliphatic ester of (meth)acrylic acid, (b) at least 20% by weight, such as at least 30% by weight and/or up to 60% by weight, such as up to 40% by weight, of a hydroxyl-functional free-radically polymerizable monomer, (c) at least 1% by weight, such as at least 2% by weight and/or up to 5% by weight, such as up to 4% by weight, of a carboxyl-functional free-radically polymerizable monomer, and (d) at least 10% by weight, such, as at least 20% or at least 30% by weight and/or up to 80% by weight, such as up to 60% or up to 50% by weight, of a hydroxyl- and carboxyl-free, (meth)acrylic ester with C₁ to C₁₈ hydrocarbon radicals in the alcohol moiety and/or a vinylaromatic and/or vinyl ester, wherein die foregoing weight percents are based on the total weight of reactants used to prepare the copolymer.

Examples of suitable cycloaliphatic esters of (meth)acrylic acid include, but are not limited to, cyclohexyl (meth)acrylate, cyclohexyl (meth)acrylates substituted in the ring by alkyl groups, 4-tert-butyl cyclohexyl (meth)acrylate, norbornyl (meth)acrylate, and/or isobornyl (meth)acrylate. As used herein, the term “(meth)acrylate” encompasses acrylate and methacrylate.

Examples of suitable hydroxyl-functional free-radical polymerizable monomers include, without limitation, hydroxyl-functional (meth)acrylic esters with C₁-C₁₈ hydrocarbon radicals in the alcohol moiety, such as, for example, hydroxyethyl (meth)acrylate, hydroxypropyl (meth)acrylate, and/or hydroxybutyl (meth)acrylate. Suitable hydroxyl-functional free-radically polymerizable monomers also include monomers containing alkylene oxide units, such as adducts of ethylene oxide, propylene oxide or butylene oxide with (meth)acrylic acid. As used herein, “(meth) acrylic” encompasses acrylic and methacrylic.

Suitable carboxyl-functional free-radical polymerizable monomers include, without limitation, olefinically unsaturated monomers with carboxylic acid or carboxylic anhydride groups, such as acrylic acid, methacrylic acid, β-carboxyethyl acrylate, crotonic acid, fumaric acid, maleic acid (anhydride), itaconic acid or monoalkyl esters of dibasic acids or anhydrides of any thereof, such as monoalkyl maleate.

Suitable hydroxyl- and carboxyl-free (meth)acrylic esters with C₁-C₁₈ hydrocarbon radicals in the alcohol moiety are, without limitation, ethyl (meth)acrylate, n-butyl (meth)acrylate, iso-butyl (meth)acrylate, 2-ethylhexyl (meth)acrylate, methyl (meth)acrylate. Suitable vinylaromatic and vinyl esters include, for example, styrene, vinyltoluene, and α-methyl styrene.

In some cases, free-radical polymerizable monomers containing phosphate/phosphonate groups or sulfonic/sulfonate groups may be used. Suitable examples include the compounds as described, for example, in WO-A 00/39181 (p. 8 line 13 p. 9 line 19). One specific suitable example is 2-acrylamido-2-methylpropanesulphonic acid.

In some cases, vinyl monomers and/or (meth)acrylate monomers with a functionality of two or more, such as hexanediol di(meth)acrylate for example, may be used in amounts of, for example, up to 2% by weight, based on the total weight of reactants used to make the copolymer. Also, monomers containing other functional groups, such as epoxy groups, alkoxysilyl groups, urea groups, urethane groups, amide groups or nitrile groups, can be used.

The acrylic copolymer may be prepared by conventional free-radical polymerization techniques in an organic phase or in an aqueous phase. In some embodiments, the copolymer is prepared by polymerization in an organic phase with subsequent dispersing of the resin into the aqueous phase, the acid groups being at least partly neutralized before or during the operation of dispersing the resin. In some embodiments, it may be desirable to employ a multistage polymerization technique as described, for example, in EP-A 0 947 557 at page 3, line 2 to page 4, line 15 or in EP-A 1 024 184 at page 2, line 53 to page 4, line 9, the cited portions of each of which being incorporated herein by reference. In such a case, a comparatively hydrophobic monomer mixture containing few or no acid groups is often prepared, and at a later point in time during the polymerization, a more hydrophilic monomer mixture containing acid groups is metered in.

Instead of a multistage polymerization technique it is possible to conduct the operation continuously (gradient polymerization). In other words, a monomer mixture with a composition, which changes is added, the hydrophilic (acid-functional) monomer fractions being higher towards the end of the feed than at the beginning.

The polymerization may be conducted in the presence of a solvent or solvent/water mixture, which may be charged to the reaction vessel at the outset. Suitable organic solvents include any of those commonly used as cosolvents in aqueous dispersions, such as alcohols, ethers, ether-functional alcohols, esters, ketones, N-methylpyrrolidone or apolar hydrocarbons, or mixtures of these solvents. The solvents are often used in amounts such that the solvent content of the finished dispersion is 0 to 12% by weight, and in some cases 1 to 10% by weight. The solvents) used may also be at least partially removed by distillation, if particularly low organic solvent contents are desired.

The copolymerization often conducted at from 40 to 200° C., such as 60 to 180° C., or, in some cases, 80 to 160° C.

In some cases, an initiator is used for the polymerization. Suitable initiators include, without limitation, organic peroxides, such as di-tert-butyl peroxide or tert-butyl peroxy-2-ethylhexanoate, and azo compounds such as azodiisobutyronitrile (AIBN). The amount of initiator used often depends on the desired molecular weight. It is possible to use initiators that are in the form of a solution in suitable organic solvents of the type mentioned above.

In certain embodiments of the present invention, the polymerization is conducted in the presence of a hydrophobic, acrylic copolymer, such as a copolymer having a number average molecular weight: of 1500 to 20000 g/mol, such as 2000 to 6000 g/mol; a hydroxyl group content of 0.5 to 7 wt. %, such as 1 to 4 wt. %, based on the total weight of the copolymer; and an acid number of <10 mg KOH/g copolymer solids, which is not sufficient for dispersing the copolymer by itself in water.

In certain embodiments, such a hydrophobic acrylic copolymer is prepared from vinyl monomers that are free from hydroxyl and acid groups, hydroxy-functional vinyl monomers, in some cases, and carboxyl-functional monomers.

Examples of monomers free from hydroxyl and acid groups include (meth)acrylic acid esters with C₁ to C₁₈-hydrocarbon radicals in the alcohol portion, such as ethyl (meth)acrylate, n-butyl (meth)acrylate, iso-butyl (meth)acrylate, 2-ethylhexyl (meth)acrylate, methyl (meth)acrylate: styrene; vinyltoluene; α-methylstyrene; a vinyl ester, a vinyl monomer containing alkylene oxide units, such as a condensation product of (meth)acrylic acid with an oligoalkylene oxide monoalkyl ether, and mixtures of these and other monomers.

Examples of hydroxy-functional vinyl monomers and carboxyl-functional monomers include those described above.

In some embodiments, the hydrophobic acrylic copolymer is employed in an amount of 0 to 40% by weight, such as 10 to 25% by weight, based on the weight of the acrylic polyol copolymer described above. The hydrophobic acrylic copolymer can be present in solvent-free form or as a solution in organic solvents, with a solids content of, for example, at least 40% by weight, based on the total weight of the solution.

In other embodiments, the polymerization of acrylic resin is conducted in the presence of a polyester according to formula (I):

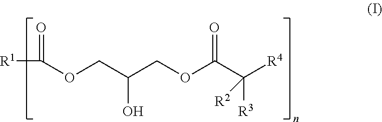

where R¹ is an aliphatic, araliphatic or aromatic radical having 1 to 18 carbon atoms, such as 2 to 6 or 2 to 4 carbon atoms, R² is H or CH₃, R³ and R⁴ are identical or different aliphatic radicals having 1 to 7 carbon atoms, and n is 1 to 4, such as 2. As will be appreciated, such a polymerization yields a polyester-acrylic dispersion.

Compounds according to the formula (I) can be the reaction product of a glycidyl ester of an aliphatic carboxylic acid (such as a glycidyl ester of Versatic™ acid, such as Cardura® E10P from Momentive Specialty Chemicals Inc.) with an aliphatic, araliphatic and/or aromatic carboxylic acid. Suitable such acids include saturated aliphatic monocarboxylic acids, such as acetic, propionic, butyric, pentanoic, hexanoic, heptanoic, octanoic, 2-ethylhexanoic, nonanoic, decanoic, lauric, myristic, palmitic, margaric, stearic, arachidic, behenic, or lignoceric acid; unsaturated monocarboxylic acids, such as oleic, linoleic, linolenic, or ricinoleic acid; aromatic monocarboxylic acids, such as benzoic acid; aliphatic dicarboxylic or polycarboxylic acids, such as succinic, glutaric, adipic, pimelic, suberic, azelaic, sebacic, nonanedicarboxylic, decanedicarboxylic; dimer fatty acids, which are obtainable by dimerizing unsaturated monocarboxylic acids; and aromatic dicarboxylic or polycarboxylic acids, such as terephthalic, isophthalic, o-phthalic, tetrahydrophthalic, hexahyrophthalic or trimellitic acid, for example. It is of course also possible to use mixtures of two or more of any of the foregoing acids.

The compound of formula (I) can be can be prepared at, tor example, a temperature of from 50 to 200° C., such as 90 to 140° C.

The amount of compound of formula (I) in relation to the amount of the acrylic resin described above in the aqueous dispersion is often 5 to 60% by weight, such as 10 to 30% by weight or, in some cases, 15 to 30% by weight.

In some of these embodiments, the polyester-acrylic dispersion comprises a copolymer reaction product of reactants comprising: (a) a hydroxyl-free (meth)acrylic ester and/or a vinylaromatic (such as any of those described above), (b) a hydroxy-functional vinyl monomers and/or hydroxy-functional (meth)acrylic ester (such as any of those described above), (c) an ionic and/or potentially ionic monomer capable of free-radical copolymerization (such as any of those described above), and (d) optionally further monomers, other than the compounds of components (a)-(c), capable of free-radical copolymerization, in which the copolymer is reacted in the presence of a compound of formula (I). In some of these embodiments, the copolymer has a hydroxyl number of from 50 to 150 mg KOH/g copolymer solids, an acid number of from 15 to 25 mg KOH/g copolymer solids, and a number-average molecular weight of from 1500 to 10000 g/mol. Moreover, in some of these embodiments, the copolymer comprises a reaction product of reactants comprises: (i) 50 to 85% by weight, such as 60 to 80% by weight, of component (a), (ii) 15 to 40% by weight, such as 20 to 30% by weight, of component (b), (iii) 0.5 to 5% by weight, such as 1 to 4% by weight, of component (c), and (iv) 0 to 34.5% by weight of component (d), wherein the weights percents are based on the total weight of reactants used to make the copolymer and wherein, in some embodiments, the above .ranges add up to 100% by weight.

Before, during or after the dispersing of the acrylic copolymer polyol in water the acid groups present are at least proportionally converted into their salt form by adding a suitable neutralizing agent. Suitable neutralizing agents include organic amines or water-soluble inorganic bases, such as soluble metal hydroxides, metal carbonates or metal hydrogen carbonates, for example.

Examples of suitable amines are N-methylmorpholine, triethylamine, ethyldiisopropylamine, N,N-dimethylethanolamine, N,N-dimethylisopropanol-amine, N-methyldiethanolamine, diethylethanolamine, triethanolamine, butanolamine, morpholine, 2-aminomethyl-2-methylpropanol or isophorone-diamine. In mixtures it is also possible proportionally to use ammonia.

In some embodiments, the neutralizing agent comprises thiethanolamine in an amount at least corresponding to a degree of neutralization of the carboxyl groups of the acrylic resin of at least 25%, and in some cases at least 40%. In other embodiments, the neutralizing agent comprises triethanolamine in an amount corresponding to a degree of neutralization of less than 25 mol %, such as less than 10 mol %, less than 5 mol %, less than 1 mol %, or 0 mol % of the carboxylic acid groups of the acrylic resin.

The neutralizing amines are added in an amount such that the degree of neutralization present, i.e., the molar ratio of neutralizing agent to acid, is 40 to 150%, such as 60 to 120%. The pH of the aqueous dispersion is often 6.0 to 10.0, such as 6.5 to 9.0.

In certain embodiments, the aqueous dispersion has a solids content of 25 to 65% by weight, such as 35 to 60% by weight, based on the total weight of the dispersion.

In certain embodiments, the acrylic resin exhibits one or more of the following: (a) a number-average molecular weight of 500 to 30000 g/mol, such as 1000 to 15000 g/mol, and in other cases 1500 to 10000 g/mol; (b) a hydroxyl content of 3.5 to 7.5% by weight, such as 3.8 to 6% by weight, based on the total weight of the resin (and is determined by the relative amount of the hydroxyl-functional monomers used and also, where appropriate, of the hydrophobic copolymer or polyester included in the initial charge); and (c) an amount of acid groups, forming the sum of carboxyl/carboxylate, phosphate/phosphonate and sulfonic acid/sulfonate groups, of 5 to 100 meq/100 g resin solids, such as 10 to 80 meq/100 g resin solids (and is determined by the relative amount of acid-functional monomers used and, where appropriate, by small amounts of acid groups in the hydrophobic copolymer or polyester included in the initial charge).

Specific examples of aqueous dispersions of a resin comprising functional groups reactive with isocyanates, which are suitable for use in the present invention include, without limitation, BAYHYDROL® A XT 2770 (an aqueous hydroxyl-functional polyacrylic dispersion, non-volatile content 44.5%, viscosity at 23° C. about 1000 mPa·s, acid value (as supplied) of 11.5 mg KOH/g and a calculated hydroxyl content of 3.9%, based on polymer solids), BAYHYDROL® A 2601 (a hydroxy-functional acrylic dispersion, non-volatile content 44-47%, viscosity at 23° C. of 1,500 to 3,000 mPa·s, acid number (as supplied) about 10 mg KOH/g and a calculated hydroxyl content of 3.9%, based on polymer solids), and BAYHYDROL® A 2542 (a hydroxy-functional acrylic-resin dispersed in water, solid content 48-51%, viscosity at 23° C. of 1,000 to 3,500 mPa·s, and hydroxyl equivalent weight (as supplied) of about 630 g/mol), each of which from Bayer Material Science LLC,

As previously indicated, the two-component: water-based coating compositions of the present invention comprise a mixture of components comprising a hydrophilicized polyisocyanate, often a non-blocked hydrophilicized polyisocyanate.

Such polyisocyanates are often derived from, for example, isophorone diisocyanate, hexamethylene diisocyanate, 1,4-diisocyanatocyclohexane, bis(4-isocyanatocyclohexane)methane, 1,3-diisocyanatobenzene, triisocyanatononane or the isomeric 2,4- and 2,6-TDI and may further contain urethane, isocyanurate and/or biuret groups.

In certain embodiments, the coating composition comprises a low-viscosity, hydrophilicized polyisocyanate formed from an aliphatic diisocyanate, in some cases a cycloaliphatic diisocyanate. Such polyisocyanates may, for example, have a viscosity at 23° C. and at least 99% solids, of at least 10 mPa·s, such as at least 100 mPa·s, at least 1000 mPa·s, at least 2000 mPa·s, at least 2500 mPa·s, or at least. 3000 mPa·s and/or no more than 5000 mPa·s, such as no more than 4500 mPa·s or no more than 4000 mPa·s. In certain embodiments, the aliphatic polyisocyanate has an isocyanate content of 7.0 to 23.0% by weight, such as 10.0 to 22.0% by weight, or, in some cases, 20.7-21.7% by weight. In certain embodiments, the polyisocyanate has an average isocyanate functionality of at least 2.0, such as at least 2.4, at least 2.9or at least 3.0 and/or no more than 5.0, no more than 4.8, no more than 4.0 or no more than 3.8. In certain embodiments, the polyisocyanate has an average isocyanate functionality of 3.2.

Water-soluble or dispersible, i.e., hydrophilicizied, polyisocyanates are obtainable, for example, by modification with carboxylate, sulfonate and/or polyethylene oxide groups and/or polyethylene oxide/polypropylene oxide groups. Hydrophilicization of the polyisocyanates is possible, for example, by reaction with substoichiometric amounts of monohydric, hydrophilic polyether alcohols. The preparation of hydrophilicized polyisocyanates of this kind is described, for example, in EP-A 0 540 985 at page 3, line 55 to page 4, line 5, the cited portion of which being incorporated herein by reference.

Also suitable are the polyisocyanates containing allophanate groups that are described in EP-A 959 087 at page 3, lines 39 to 51, the cited portion of which being incorporated herein by reference, which are prepared by reacting low-monomer-content polyisocyanates with polyethylene oxide polyether alcohols under allophanatization conditions. Also suitable are the water-dispersible polyisocyanate mixtures formed from triisocyanatononane as described in DE-A 100 078 21 at page 2, line 66 to page 3, line 5 and the polyisocyanates hydrophilicized with ionic groups (such as sulfonate groups and/or phosphonate groups), as described, for example, in DE 100 24 624 at page 3, lines 13 to 33, the cited portions of each of which being incorporated herein by reference.

One example of a hydrophilic aliphatic polyisocyanate formed from hexamethylene diisocyanate, which is suitable for use in the present invention, is BAYHYDUR® XP 2655, from Bayer Material Science LLC (which has a viscosity at 23° C. and 100% solids of 3500 mPa·s, an isocyanate content of 21.2% by weight, and an average isocyanate functionality of 3.2). Another example of a hydrophilic aliphatic polyisocyanate formed from hexamethylene diisocyanate, which is suitable for use in the present invention, is BAYHYDUR® 304, from Bayer Material Science LLC (which has a viscosity at 23° C. and 100% solids of 3000-6000 mPa·s, an isocyanate content of 17.5%-18.5%, and an average isocyanate functionality of 3.8).

The coating compositions of the present invention may comprise any customary auxiliaries and additives of paint technology, such as defoamers, thickeners, pigments, dispersing assistants, catalysts, anti-skinning agents, anti-settling agents or emulsifiers, for example.

As indicated earlier, in the coating compositions of the present invention, the mixture comprises propylene carbonate that is present in the mixture in an amount of greater than 2 percent by weight, such as greater than 2 to 15 percent by weight, or, in some cases, 3 to 10 percent by weight, based on the total weight of the mixture. As will be appreciated, propylene carbonate is a carbonate ester derived from propylene glycol and has the structure:

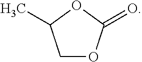

It has been surprisingly discovered that inclusion of low levels (amounts within the ranges described above) of propylene carbonate in the coating compositions of the present invention can provide two-component water-based coating compositions that use a hydrophilicized polyisocyanate and which produces high gloss coatings that are free of pin-holes and have a very high DOI. It has also been surprisingly discovered that inclusion of propylene carbonate in the coating compositions of the present invention, in an amount within the ranges described above, provides a robust solution in that it can be used effectively with a variety of different resins comprising functional groups that are reactive with isocyanates.

In preparing the coating compositions of the present invention, the propylene carbonate can be included as part of component (a) or component (b) or it can be added as a third component to a mixture of component (a) and component (b). In certain embodiments of the present invention, the propylene carbonate is included as a portion of component (b).

To prepare the coating composition of the present invention, the components are mixed to form a mixture in which the ratio of isocyanate groups to groups reactive with isocyanate groups, such as hydroxyl groups, in the mixture is in the range of 0.8 to 3.0:1, such as 1.0 to 3.0:1, 1.1 to 2.0:1, or 1.1 to 1.5:1.

The coating compositions described herein may be applied on to surfaces using various techniques, such as spraying, dipping, flow coating, rolling, brushing, pouring, and the like. Solvents present in the applied coating evaporate and the coating cures due to the urethane-forming crosslinking reaction, between the polyisocyanates and the active-hydrogen containing components. The crosslinking reactions may occur under ambient conditions or at higher temperatures of, tor example, 40° C. to 200° C. In certain embodiments, the coating composition is applied such that the cured coating has a dry film thickness of at least 3 mils (at least 76.2 μm), such as 3 to 6 mils (76.2 μm to 152.4 μm), or 3 to 5 mils (76.2 μm to 127 μm).

The coating compositions can be applied onto any compatible substrate, such as, for example, metals, plastics, ceramics, glass, and natural materials, and to substrates that have been, subjected to any pre-treatment that may be desirable. In certain embodiments, the coating composition is employed as a topcoat, which, as used herein, refers to a coating layer that is tire outermost coating layer, that is, a coating layer that is in contact with the external environment and that is coated over any other layers. In certain embodiments, the topcoat is formed on a substrate that forms a component part of an automotive or aerospace vehicle.

Methods for using the coating compositions described herein include those that comprise; (a) depositing the mixture over at least a portion of the substrate, and (b) allowing the coating composition to cure at ambient conditions to form a cured coating having a 20° gloss (ASTM D523-89) of at least 80 gloss units, such as at least 85 gloss units, or, in some cases, at least 88 gloss units. In certain embodiments, such cured coatings also have a wavescan DOI value (which can be determined according to ASTM D5767-95) of at least 90 or, in some cases, at least 95, as determined by a surface texture analyzer, model “Wave-Scan DOI”, from BYK-Gardner USA (an ideally smooth surface would have a wavescan DOI value of 100). These cured coatings are also free of pin-holes. As used herein, “free of pin-holes” means that the cured coating does not contain any holes that are visible to tire naked eye. As used herein, “ambient conditions” means the temperature, and pressure of the surroundings in which the substrate is located and, when indoors, is synonymous with the temperature and pressure of the atmosphere in the room in which the substrate is located.

As will be appreciated from the foregoing, embodiments of the present invention are directed to two-component water-based polyurethane coating compositions comprising a mixture of components comprising: (a) an aqueous dispersion of a resin, comprising functional groups reactive, with isocyanates; and (b) a hydrophilicized polyisocyanate, wherein the mixture: (i) comprises propylene carbonate that is present in the mixture in an amount of greater than 2 percent by weight, based on the total weight of the mixture; and (ii) has a ratio of isocyanate groups to functional groups reactive with isocyanates (such as hydroxyl groups) of 0.8 to 3.0:1.

Some, embodiments of the present invention are directed to a coating composition of the previous paragraph, wherein (a) comprises an acrylic resin, which, in some embodiments, is prepared in the. presence of a hydrophobic acrylic resin and/or a polyester

Embodiments of the present invention are directed to a coating composition of the previous paragraph, wherein the acrylic resin comprises a copolymer that is a reaction product of reactants comprising: (a) up to 50% by weight, such as at least 10% by weight or at least 20% by weight and up to 50% by weight or up to 30% by weight, of a cycloaliphatic ester of (meth)acrylic acid, (b) at least 20% by weight, such as at least 30% by weight and/or up to 60% by weight, such as up to 40% by weight, of a hydroxyl-functional free-radically polymerizable monomer, (c) at least 1% by weight, such as at least 2% by weight: and/or up to 5% by weight, such as up to 4% by weight, of a carboxyl-functional free-radically polymerizable monomer, and (d) at least 10% by weight, such as at least 20% or at least 30% by weight and/or up to 80% by weight, such as up to 60% or up to 50% by weight, of a hydroxyl- and carboxyl-free (meth)acrylic ester with C₁ to C₁₈ hydrocarbon radicals in the alcohol moiety and/or a vinylaromatic and/or vinyl ester, wherein the foregoing weight percents are based on the total weight of reactants used to prepare the copolymer.

Some embodiments of the present invention are directed to a coating composition of the previous paragraph, wherein (a) comprises one or both of isobornyl acrylate and isobornyl methacrylate.

In some embodiments, the present invention is directed to a coating composition of any of the previous two paragraphs, in which the hydroxyl content of the resin is 3.5 to 7.5% by weight, based on the weight of the resin.

Some embodiments of the present invention are directed to a coating composition of any of the previous three paragraphs, in which the acid number of the acrylic resin is 10 to 40 mg KOH/g resin solids.

Some embodiments of the present invention are directed to a coating composition of any of the previous five paragraphs, wherein the acrylic resin is prepared in the presence of a hydrophobic acrylic copolymer that has a number average molecular weight of 1500 to 20000 g/mol, such as 2000 to 6000 g/mol, a hydroxyl group content of 0.5 to 7 wt %, such, as 1 to 4 wt %, based on the weight of the copolymer, and/or an acid number of <10 mg KOH/g copolymer solids.

Embodiments of the present invention are also directed to a coating composition of paragraph [0065], wherein the acrylic resin is prepared in the presence of a polyester having the formula;

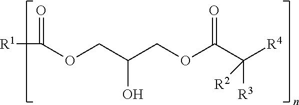

where R¹ is an aliphatic, araliphatic or aromatic radical having 1 to 18 carbon atoms, such as 2 to 6 or 2 to 4 carbon atoms, R² is H or CH3, R³ and R⁴ are identical or different aliphatic radicals having 1 to 7 carbon atoms, and n is 1 to 4, such as 2.

In certain embodiments, the present invention is directed to a coating composition of the previous paragraph, wherein the polyester is the reaction product of a glycidyl ester of an aliphatic carboxylic acid, such as a glycidyl ester of Versatic™ acid, with a carboxylic acid.

Some embodiments of the present invention are directed to a coating composition of any of the previous two paragraphs, wherein the acrylic resin comprises a reaction product of reactants comprising: (i) 50 to 85% by weight, such as 60 to 80% by weight, of component (a), (ii) 15 to 40% by weight, such as 20 to 30% by weight, of component (b), (iii) 0.5 to 5% by weight, such as 1 to 4% by weight, of component (c), and (iv) 0 to 34,5% by weight of component (d), wherein the weights percents are based on the total weight of reactants used to make the copolymer and wherein, in some embodiments, the above ranges add up to 100% by weight.

In some embodiments, the present invention is directed to a coating composition of any of the previous nine paragraphs, wherein at least 25 mol %, such as at least 40 mol %, of the carboxylic acid groups of the acrylic resin are present in triethanolamine-neutralized form. Alternatively, in some embodiments, the present invention is directed to a coating composition of any of the previous nine paragraphs, wherein less than 25 mol %, such as less than 10 mol %, less than 5 mol %, less than 1 mot %, or 0 mol % of the carboxylic acid groups of the acrylic resin are present in triethanolamine-neutralized form.

In some embodiments, the present invention is directed to a coating composition of any of the previous ten paragraphs, wherein the acrylic resin has a hydroxyl number of from 50 to 150 mg KOH/g resin solids, an acid number of from 15 to 25 mg KOH/g resin solids and/or a number-average molecular weight of 1500 to 10000 g/mol.

Some embodiments of the present invention are directed to a coating composition of any of the previous twelve paragraphs, wherein the hydrophilicized polyisocyanate comprises an aliphatic polyisocyanate, such as a polyisocyanate formed from hexamethylene diisocyanate.

In some embodiments, the present invention is directed to a coating composition of the previous paragraph, wherein the hydrophilicized polyisocyanate has a viscosity at 23° C. and at least 99% solids, of at least 10 mPa·s, such as at least 100 mPa·s, at least 1000 mPa·s, at least 2000 mPa·s, at least 2500 mPa·s, or at least 3000 mPa·s and/or no more than 5000 mPa·s, such as no more than 4500 mPa·s or no more than 4000 mPa·s; an isocyanate content of 7.0 to 23.0 % by weight, such as 10.0 to 22.0 % by weight, or, in some cases, 20.7-21.7% by weight; and an average isocyanate functionality of at least 2.0, such as at least 2.4, at least 2.9 or at least 3.0 and/or no more than 5.0, no more than 4.8, no more than 4.0 or no more than 3.8, such as 3.2.

In certain embodiments, the present invention is directed to a coating composition of any of the previous fourteen paragraphs, wherein the propylene carbonate is present in the mixture in an amount of greater than 2 percent by weight up to 15 percent by weight, such as 3 to 10 percent by weight, based on the total weight of the mixture.

In embodiments, the present invention is directed to a coating composition of any of the previous fifteen paragraphs, wherein the mixture has a content, of isocyanate groups to functional groups reactive with isocyanates (such as hydroxyl groups) of 1.0:1 to 3.0:1, 1.1:1 to 2.0:1, or 1.1 to 1.5:1.

Some embodiments of the present invention are directed to a method of using the coating composition of any of the previous sixteen paragraphs, comprising: (a) depositing the mixture over at least a portion of the substrate, and (b) allowing the coating composition to cure at ambient conditions to form a cured coating having a 20° gloss, measured according to ASTM D523-89, of at least 80 gloss units, such as at least 85 gloss units or at least 88 gloss units. Embodiments of the present invention are also directed to a coated substrate comprising a cured coating, such, as a top coating, having a 20° gloss, measured according to ASTM D523-89, of at least 80 gloss units, wherein the cured coating is deposited from a two-component water-based coating composition of any of the previous sixteen paragraphs.

Illustrating the invention are the following examples that do not limit the invention to their details. All parts and percentages in the examples, as well as throughout the specification, are by weight unless otherwise indicated.

### EXAMPLES

### Examples 1A-1I

Coating compositions were prepared using the ingredients and amounts (parts by weight) listed in Table 1. In each case, all of the ingredients of Component I were added under agitation to the. acrylic polyol. Component II was prepared by mixing the solvent (where applicable) with the isocyanate using a tongue depressor. Component II was then added to Component I under agitation using a spin mixer at 3500 rpm for 2 minutes. In each case, the coating composition was applied to a dry film thickness of 1.5-2.0 mils over cold rolled steel panels coated with an electrodeposition coating, epoxy primer, and colored base coat using a hand held HVLP gun (9 psi at the tip). The coatings were allowed to air dry at ambient conditions for 3 weeks. Coated panels were evaluated for gloss, distinctness of image (“DOI”), the degree of orange-peel, and the existence of pin-holes. Results are set forth in Table 1.

TABLE 1

| | | | | | | | | |
|---|---|---|---|---|---|---|---|---|
| 1A | 1B | 1C | 1D | 1E | 1F | 1G | 1H | 1I |

Component I

| | | | | | | | | | |
|---|---|---|---|---|---|---|---|---|---|
| Bayhydrol ® A 2542¹ | 103.04 | 89.55 | — | 46.15 | — | — | — | — | 46.15 |
| Bayhydrol ® A 2601² | — | — | — | 51.29 | — | — | — | — | 51.29 |
| Bayhydrol ® A XP 2770³ | — | — | 108.42 | — | 97.21 | 79.67 | 72.52 | 108.42 | — |
| Deionized water | 63.95 | 55.58 | 43.35 | 51.47 | 55.32 | 37.60 | 35.00 | 43.35 | 51.47 |
| Tinuvin ® 1130⁴ | 1.71 | 1.49 | 1.70 | 1.53 | 1.59 | 1.25 | 1.19 | 1.70 | 1.53 |
| Tinuvin ® 292⁵ | 0.85 | 0.74 | 0.85 | 0.76 | 0.79 | 0.62 | 0.59 | 0.85 | 0.76 |
| Borchigel ® PW⁶ | 0.93 | 0.81 | 0.81 | 0.83 | 0.88 | 0.60 | 0.66 | 0.81 | 0.83 |
| Surfynol ® 104 BC⁷ | 1.50 | 1.30 | 2.09 | 1.35 | 1.69 | 1.54 | 1.26 | 2.09 | 1.35 |
| Baysilone ® VP Al 3468⁸ | 1.85 | 1.61 | 1.85 | 1.67 | 2.10 | 1.36 | 1.57 | 1.85 | 1.67 |
| Irganox ® 1135⁹ | 0.40 | 0.35 | 0.42 | 0.36 | 0.35 | 0.31 | 0.26 | 0.42 | 0.36 |

Component II

| | | | | | | | | | |
|---|---|---|---|---|---|---|---|---|---|
| Bayhydur ® XP 2655¹⁰ | 48.60 | 42.24 | 32.85 | 37.58 | — | — | — | 32.85 | 37.58 |
| Bayhydur ® 302¹¹ | — | — | — | — | 36.14 | 29.58 | 26.96 | — | — |
| Butoxyl | 7.30 | — | — | — | — | — | 3.73 | — | — |
| Propylene Carbonate | — | 6.34 | 7.66 | 7.01 | — | 3.97 | — | — | — |

Theoretical Results

| | | | | | | | | | |
|---|---|---|---|---|---|---|---|---|---|
| Weight Solids | 45.06 | 45.06 | 42.41 | 43.47 | 42.24 | 43.30 | 42.98 | 44.10 | 45.05 |
| NCO:OH | 1.5:1 | 1.5:1 | 1.5:1 | 1.5:1 | 1.5:1 | 1.5:1 | 1.5:1 | 1.5:1 | 1.5:1 |
| Theoretical VOC | 0.94 | 0.37 | 0.78 | 0.87 | 0.75 | 0.72 | 1.20 | 0.78 | 0.87 |

Test Results

| | | | | | | | | | |
|---|---|---|---|---|---|---|---|---|---|
| Gloss (20°)¹² | 86 | 87 | 88 | 88 | 82 | 86 | 65 | 82 | 85 |
| Gloss (60°)¹² | 92 | 92 | 92 | 92 | 90 | 92 | 85 | 90 | 92 |
| DOI¹³ | 93.5 | 91 | 97 | 93 | 80 | 91 | 77 | 81 | 81 |
| Degree of Orange Peel¹³ | 2.9 | 7.3 | 9.6 | 8.2 | 3.9 | 7 | 10.2 | 6 | 4.1 |
| Presence of Pin-holes¹⁴ | No | No | No | No | Yes | No | No | Yes | Yes |

¹Aqueous hydroxyl-functional polyacrylic dispersion prepared by polymerization of free-radically polymerizable monomers in the presence of a polyester according to formula (I), Bayer MaterialScienee LLC
²Hydroxyl-functional polyacrylic dispersion prepared by polymerization of free-radically polymerizable monomers in the presence of a hydrophobic acrylic copolymer, Bayer MaterialScience LLC
³Aqueous hydroxyl-functional polyacrylic dispersion prepared by polymerization of free-radically polymerizable monomers in the presence of a hydrophobic acrylic copolymer, Bayer MaterialScience LLC
⁴UV absorber, BASF
⁵Hindered amine light stabilizer, BASF
⁶Non-ionic, polyurethane-based thickener dissolved in a 4:6 solution of water/propylene glycol, OMG Borchers GmbH, Germany
⁷Nonionic surfactant, 50% active liquid in 2-Butoxyethanol, Air Products
⁸10% in butane glycol, polyether polysiloxane surface additive, Borchers GmbH
⁹Antioxidant, BASF
¹⁰Hydrophilic aliphatic polyisocyanate formed from hexamethylene diisocyanate (HDI); NCO content 20.7-21.7%; monomeric isocyanate content <0.3% by wt; viscosity 3500 ± 1000 at 25° C. mPa · s; Hazen color value ≦100, Bayer MaterialScience LLC
¹¹Water-dispersible polyisocyanate formed from hexamethylene diisocyanate (HDI); NCO content 17.3% ± 0.5; solids 99.8% minimum; viscosity 2,300 ± 700 mPa · s at 25° C., Bayer MaterialScience LLC
¹²Measured according to ASTM D523-89
¹³Measured using a surface texture analyzer, model “WaveScan DOI”, obtained from BYK- Gardner USA. Higher values represent a lower degree of orange peel and better distinctness of image.
¹⁴Measured by visual observation of coated panel with the naked eye.

### Example 2A-2L

Coating compositions were prepared using the ingredients and amounts (parts by weight) listed in Table 2. The coatings compositions were prepared, applied to a substrate, cured, and tested in the same manner as described, above with respect to Examples 1A-1I. Results are set forth in Table 2.

TABLE 2

| | | | | | | | | |
|---|---|---|---|---|---|---|---|---|
| 2A | 2B | 2C | 2D | 2E | 2F | 2G | 2H | 2I |

Component I

| | | | | | | | | | |
|---|---|---|---|---|---|---|---|---|---|
| Bayhydrol ® A XP 2770³ | 108.42 | 108.42 | 108.42 | 108.42 | 108.42 | 108.42 | 108.42 | 108.42 | 108.42 |
| Deionized water | 43.35 | 43.35 | 43.35 | 43.35 | 43.35 | 43.35 | 43.35 | 43.35 | 43.35 |
| Tinuvin ® 1130⁴ | 1.70 | 1.70 | 1.70 | 1.70 | 1.70 | 1.70 | 1.70 | 1.70 | 1.70 |
| Tinuvin ® 292⁵ | 0.85 | 0.85 | 0.85 | 0.85 | 0.85 | 0.85 | 0.10 | 0.10 | 0.10 |
| Borchigel ® PW⁶ | 0.81 | 0.81 | 0.81 | 0.81 | 0.81 | 0.81 | 0.81 | 0.81 | 0.81 |
| Surfynol ® 104 BC⁷ | 2.09 | 2.09 | 2.09 | 2.09 | 2.09 | 2.09 | 2.09 | 2.09 | 2.09 |
| Baysilone ® VP Al 3468⁸ | 1.85 | 1.85 | 1.85 | 1.85 | 1.85 | 1.85 | 1.85 | 1.85 | 1.85 |
| Irganox ® 1135⁹ | 0.42 | 0.42 | 0.42 | 0.42 | 0.42 | 0.42 | 0.42 | 0.42 | 0.42 |

Component II

| | | | | | | | | | |
|---|---|---|---|---|---|---|---|---|---|
| Bayhydur ® XP 2655¹⁰ | 32.85 | 32.85 | 32.85 | 32.85 | 32.85 | 32.85 | — | 32.85 | 32.85 |
| Desmodur ® N-3900¹⁵ | — | — | — | — | — | — | 29.75 | — | — |
| 2-Ethyl Hexanol | — | — | — | — | — | — | — | 8.00 | — |
| n-methyl pyrrolidone | — | — | — | — | — | — | — | — | 8.00 |
| Propylene Carbonate | — | 8.00 | 2.00 | 12.00 | 4.00 | 20.00 | — | — | — |

Theoretical Results

| | | | | | | | | | |
|---|---|---|---|---|---|---|---|---|---|
| Weight Solids | 44.10 | 42.34 | 43.65 | 41.51 | 43.20 | 39.95 | 43.19 | 42.34 | 42.34 |
| NCO:OH | 1.5:1 | 1.5:1 | 1.5:1 | 1.5:1 | 1.5:1 | 1.5:1 | 1.5:1 | 1.5:1 | 1.5:1 |
| Theoretical VOC | 0.78 | 0.78 | 0.78 | 0.78 | 0.78 | 0.78 | 0.80 | 1.43 | 1.46 |

Test Results

| | | | | | | | | | |
|---|---|---|---|---|---|---|---|---|---|
| Gloss (20°)¹² | 71.1 | 84.4 | 79.8 | 83.2 | 82.3 | 77.6 | 4.5 | 80.3 | 41.3 |
| Gloss (60°)¹² | 87.7 | 90.0 | 89.0 | 90.1 | 89.8 | 88.7 | 26.7 | 89.2 | 72.5 |
| DOI¹³ | 74.3 | 91.3 | 82.7 | 92.7 | 83.7 | 88.5 | — | 92.2 | 67.6 |
| Degree of Orange Peel¹³ | 2.7 | 8.2 | 6.1 | 9.1 | 6.3 | 9.2 | — | 10.5 | 6.9 |
| Presence of Pin-holes¹⁴ | Yes | No | Yes | No | Yes | No | Yes | No | Yes |

| | | |
|---|---|---|
| 2J | 2K | 2L |

Component I

| | | | |
|---|---|---|---|
| Bayhydrol ® A XP 2770³ | 108.42 | 108.42 | 108.42 |
| Deionized water | 43.35 | 43.35 | 43.35 |
| Tinuvin ® 1130⁴ | 1.70 | 1.70 | 1.70 |
| Tinuvin ® 292⁵ | 0.85 | 0.85 | 0.85 |
| Borchigel ® PW⁶ | 0.81 | 0.81 | 0.81 |
| Surfynol ® 104 BC⁷ | 2.09 | 2.09 | 2.09 |
| Baysilone ® VP Al 3468⁸ | 1.85 | 1.85 | 1.85 |
| Irganox ® 1135⁹ | 0.42 | 0.42 | 0.42 |

Component II

| | | | |
|---|---|---|---|
| Bayhydur ® XP 2655¹⁰ | 32.85 | 32.85 | 32.85 |
| Dimethyl formamide | 8.00 | — | — |
| Diethylene Glycol | — | 8.00 | — |
| Ethylene Carbonate | — | — | 8.00 |

Theoretical Results

| | | | |
|---|---|---|---|
| Weight Solids | 42.34 | 42.34 | 42.34 |
| NCO:OH | 1.5:1 | 1.5:1 | 1.5:1 |
| Theoretical VOC | 1.44 | 1.47 | 1.48 |

Test Results

| | | | |
|---|---|---|---|
| Gloss (20°)¹² | 46.7 | 53.9 | 67.2 |
| Gloss (60°)¹² | 76.5 | 83.0 | 85.7 |
| DOI¹³ | 67.0 | 67.6 | 73.9 |
| Degree of Orange Peel¹³ | 5.2 | 5.2 | 6.1 |
| Presence of Pin-holes¹⁴ | Yes | Yes | Yes |

¹⁵HDI trimer; aliphatic polyisocyanate resin formed from hexamethylene diisocyanate (HDI); NCO content ca. 24.0%; viscosity ca. 700 mPa · s at 23° C., Bayer MaterialScience, LLC

### Example 3

Coating compositions were prepared using the ingredients and amounts (parts by weight) listed in Table 3. The coatings compositions were prepared, applied to a substrate, cured, and tested in the same manner as described above with respect to Examples 1A-1I. Results are set forth in Table 3.

TABLE 3

| | | | | | |
|---|---|---|---|---|---|
| 3A | 3B | 3C | 3D | 3E | 3F |

Component I

| | | | | | | |
|---|---|---|---|---|---|---|
| Bayhydrol ® A 2542¹ | — | — | 21.26 | 21.16 | 22.58 | 22.63 |
| Bayhydrol ® A XP 2770³ | 52.11 | 52.06 | — | — | — | — |
| Bayhydrol ® A 2601² | — | — | 23.55 | 23.53 | 25.11 | 25.05 |
| Borchigel ® PW⁶ | 0.46 | 0.44 | 0.43 | 0.45 | 0.5 | 0.48 |
| Surfynol ® 104 BC⁷ | 1.04 | 1.03 | 0.62 | 0.64 | 0.8 | 0.78 |
| Baysilone ® VP Al 3468⁸ | 0.9 | 0.92 | 0.97 | 0.92 | 0.83 | 0.92 |
| Tinuvin ® 1130⁴ | 0.85 | 0.92 | 0.9 | 0.88 | 0.86 | 0.89 |
| Tinuvin ® 292⁵ | 0.42 | 0.42 | 0.49 | 0.48 | 0.43 | 0.42 |
| Irganox ® 1135⁹ | 0.32 | 0.31 | 0.32 | 0.33 | 0.22 | 0.21 |
| Deionized water | 21.18 | 21.18 | 27.06 | 27.28 | 26.51 | 26.35 |

Component II

| | | | | | | |
|---|---|---|---|---|---|---|
| Bayhydur ® 304¹⁶ | 18.79 | 18.78 | 20.39 | 20.36 | — | — |
| 2-Ethyl Hexanol | 3.94 | — | 4 | — | 3.86 | — |
| Propylene Carbonate | — | 3.94 | — | 3.97 | — | 3.9 |
| Bayhydur ® XP 2655¹⁰ | — | — | — | — | 18.3 | 18.38 |

Theoretical Results

| | | | | | | |
|---|---|---|---|---|---|---|
| Weight Solids | 43.95 | 43.97 | 43.61 | 43.5 | 42.71 | 42.8 |
| NCO:OH | 1.51 | 1.51 | 1.51 | 1.51 | 1.5 | 1.5 |
| Theoretical VOC | 1.32 | 0.71 | 1.41 | 0.81 | 1.5 | 0.9 |

Test Results

| | | | | | | |
|---|---|---|---|---|---|---|
| Gloss (20°)¹² | 79.6 | 87.1 | 82.9 | 86.5 | 86.9 | 88.8 |
| Gloss (60°)¹² | 90.1 | 92.4 | 90.3 | 93.2 | 92.9 | 93.2 |
| DOI¹³ | 85.2 | 95.6 | 75 | 96.9 | 94.2 | 96.9 |
| Degree of Orange Peel¹³ | 9.9 | 9.8 | 10.01 | 10.05 | 10.05 | 10.05 |
| Presence of Pin-holes¹⁴ | No | No | No | No | No | No |

¹⁶An aliphatic water-dispersible polyisocyanate based on hexamethylene diisocyanate (HDI); NCO content 18.0% ± 0.5; solids 100%; viscosity 4,500 ± 1,500 mPa · s at 23° C., Bayer MaterialScience, LLC.

Although the invention has been described in detail in the foregoing for the purpose of illustration, it is to be understood that such detail is solely for that purpose and that variations can be made therein by those skilled in the art without departing from the spirit and scope of the invention except as may be limited by the claims.

What is claimed is:

1. A two-component water-based coating composition comprising a mixture of components comprising:
(a) an aqueous dispersion of a resin comprising functional groups reactive with isocyanates; and
(b) a hydrophilicized polyisocyanate,
wherein the mixture:
(i) comprises propylene carbonate that is present in the mixture in an amount of greater than 2 percent by weight, based on the total weight of the mixture; and
(ii) has a ratio of isocyanate groups to functional groups reactive with isocyanates of 0.8 to 3.0:1.

2. The coating composition of claim 1, wherein (a) comprises an acrylic resin.

3. The coating composition of claim 2, wherein the acrylic resin comprises a copolymer that is a reaction product of reactants comprising:
(A) 10 to 50% by weight of a cycloaliphatic ester of (meth)acrylic acid,
(B) 20 to 60% by weight of a hydroxyl-functional free-radically polymerizable monomer,
(C) 1 to 5% by weight of a carboxyl-functional free-radically polymerizable monomer, and
(D) 10 to 60% by weight of a hydroxyl- and carboxyl-free (meth)acrylic ester with C₁ to C₁₈ hydrocarbon radicals in the alcohol moiety and/or a vinylaromatic and/or vinyl ester,
wherein the weight percents are based on the total weight, of reactants used to prepare the copolymer.

4. The coating composition of claim 3, wherein (A) comprises one or both of isobornyl acrylate and isobornyl methacrylate.

5. The coating composition of claim 2, wherein the hydroxyl content of the acrylic resin is 3.5 to 7.5% by weight, based on the weight of the acrylic resin.

6. The coating composition of claim 2, wherein the acid number of the acrylic resin is 10 to 40 mg KOH/g of resin solids.

7. The coating composition of claim 2, wherein the acrylic resin is prepared in the presence of a hydrophobic acrylic resin and/or a polyester.

8. The coating composition of claim 7, wherein the acrylic resin is prepared in the presence of a hydrophobic acrylic resin that is a copolymer having a number average molecular weight of 1500 to 20000 g/mol, a hydroxyl group content of 0.5 to 7% by weight based on the weight of the copolymer, and/or an acid number of <10 mg KOH/g copolymer solids.

9. The coating composition of claim 7, wherein the acrylic resin is prepared in the presence of a polyester that has the formula: 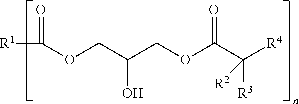
where R¹ is an aliphatic, araliphatic or aromatic radical having 1 to 18 carbon atoms, R² is H or CH₃, R³ and R⁴ are identical or different aliphatic radicals having 1 to 7 carbon atoms, and n is 1 to 4.

10. The coating composition of claim 9, wherein the acrylic resin has a hydroxyl number of 50 to 150 mg KOH/g of resin solids, an acid number of 15 to 25 mg KOH/g of resin solids and/or a number-average molecular weight of 1500 to 10000 g/mol.

11. The coating composition of claim 9, wherein the acrylic resin comprises a reaction product of reactants comprising:
(i) 50 to 85% by weight of component (A),
(ii) 15 to 40% by weight of component (B),
(iii) 0.5 to 5% by weight of component (C) and
(iv) 0 to 34.5% by weight of component (D),
wherein the weight percents are based on the total weight of tire reactants used to make the acrylic resin and wherein the amounts add up to 100% by weight.

12. The coating composition of claim 1, wherein the hydrophilicized polyisocyanate comprises an aliphatic polyisocyanate formed from hexamethylene diisocyanate.

13. The coating composition of claim 12, wherein the hydrophilicized polyisocyanate has a viscosity at 23° C. and at least 99% solids of 1000 mPa·s to 5000 mPa·s.

14. The coating composition of claim 13, wherein the hydrophilicized polyisocyanate has an average isocyanate fuctionality of 2.4 to 3.8.

15. The coating composition of claim 1, wherein the propylene carbonate is present in the mixture in an amount of 3 to 10 percent by weight, based on the total weight of the mixture.

16. The coating composition of claim 15, wherein the mixture has a content of isocyanate groups to functional groups reactive with isocyanates of 1.1:1 to 2.0:1.

17. A method of using the coating composition of claim 1, comprising:
(a) depositing the mixture over at least a portion of a substrate, and
(b) allowing the coating composition to cure at ambient conditions to form a cured coating having a 20° gloss, measured according to ASTM D523-89, of at least 80 gloss units.

18. The method of claim 17, wherein the 20° gloss is at least 85 gloss units.

19. A coated substrate comprising a cured coating having a 20° gloss, measured according to ASTM D523-89, of at least 80 gloss units, wherein the cared coating is deposited from a two-component water-based coating composition of claim 1.

20. The substrate of claim 19, wherein the cured coating is a top coating.
